(19) United States
(12) Patent Application Publication
(10) Pub. No.: US 2007/0008912 A1
(43) Pub. Date: Jan. 11, 2007

(54) Method For Establishing Telephone Communication With A Wireless Web Phone In A Wireless Communication System

(76) Inventor: Cheng-Su Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/160,421

(22) Filed: Jun. 23, 2005

(51) Int. Cl. H04L 12/16

(52) U.S. Cl. 370/260

(57) ABSTRACT

A method for establishing telephone communication with a wireless web phone capable of establishing a wireless local area network connection in a wireless communication system includes receiving network information of the wireless web phone when the wireless web phone calls a destination, transmitting the network information of the wireless web phone to the destination through a communication network, and establishing telephone communication with the destination through the Internet when a response from the destination represents that the destination is capable of establishing an Internet connection.

### BACKGROUND OF THE INVENTION

1. Field of the Invention

The present invention provides a method for establishing telephone communication with a wireless web phone in a wireless communication system, and more particularly, a method for decreasing a server's load when establishing telephone communication.

2. Description of the Prior Art

With the highly developed and popular Internet, communication becomes more and more convenient. In the past, real-time voice communication could only be realized through a public switched telephone network, or PSTN, but now, the technology of voice over Internet protocol, or VOIP, makes real-time voice communication through the Internet possible. VOIP technology provides not only high-quality voice communication, but also real-time exchange of images, data, etc. because the Internet has a larger bandwidth than the PSTN. Moreover, charges for Internet communication, especially for long-distance communication, are much cheaper than those for PSTN communication.

Therefore, communication through the Internet provides high-quality voice and image exchange services with cheap charges. However, a prior art web phone communicates with other web phone through a substantial line, such as an ADSL, so the web phone cannot perform mobile communication. Generally, charges for prior art mobile communication, especially for long-distance and international communications, are more expensive than those for PSTN communication, but the mobile communication cannot provide services for the real-time exchange of images and data owing to a narrow frequency band. Therefore, to establish mobile communication through the Internet is expected.

### SUMMARY OF THE INVENTION

It is therefore a primary objective of the claimed invention to provide a method for establishing telephone communication with a wireless web phone in a wireless communication system.

The present invention discloses a method for establishing telephone communication with a wireless web phone capable of establishing a wireless local area network connection in a wireless communication system. The method includes: receiving network information of the wireless web phone when the wireless web phone calls a destination; transmitting the network information of the wireless web phone to the destination through a communication network; and establishing telephone communication with the destination through the Internet when a response from the destination represents that the destination is capable of establishing an Internet connection.

The present invention further discloses a method for receiving network information of a web phone, which includes: receiving the network information of the web phone from a plurality of communication devices having established network connections with the web phone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a process for establishing a telephone communications with a wireless web phone in a wireless communication system in accordance with the first embodiment of the present invention.

FIG. 2 illustrates a flowchart of a process for establishing a telephone communications with a wireless web phone in a wireless communication system in accordance with the second embodiment of the present invention.

### DETAILED DESCRIPTION

With the highly developed wireless communication technology, an Internet connection can be established through a wireless local area network (WLAN). Under such concept, the present invention uses a mobile phone capable of establishing a WLAN connection, which is named a wireless web phone herein.

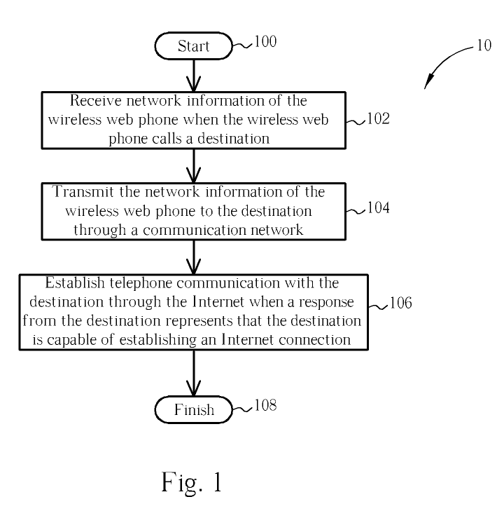

Please refer to FIG. 1, which illustrates a flowchart of a process 10 for establishing telephone communication with a wireless web phone in a wireless communication system in accordance with the first embodiment of the present invention. The process 10 includes following steps:

Step 100: start.

Step 102: receive network information of the wireless web phone when the wireless web phone calls a destination.

Step 104: transmit the network information of the wireless web phone to the destination through a communication network.

Step 106: establish telephone communication with the destination through the Internet when a response from the destination represents that the destination is capable of establishing an Internet connection.

Step 108: finish.

In a WLAN, each mobile device does not have a fixed real IP (Internet protocol) address. Therefore, in the present invention, when calling a destination, a wireless web phone tries to receive its network information, such as an IP address and an available port. After receiving the network information, the wireless web phone transmits the network information to the destination through a network. If a response from the destination represents that the destination is capable of establishing an Internet connection, then the wireless web phone establishes telephone communication with the destination through the Internet. That is, when establishing telephone communication, the wireless web phone transmits its network information to the destination, so that the destination can know the real IP address and the available port of the wireless web phone. Moreover, the present invention can transmit the network information through a global system for mobile communication to the destination. If the destination can establish the Internet connection, then the destination can communicate with the wireless web phone through the Internet according to the IP address and the available port of the wireless web phone stored in the network information. As a result, the wireless web phone establishes telephone communication with low charges and high quality, and can provide services for the real-time exchange of images and files.

Furthermore, the present invention provides different implementations for receiving the network information of the wireless web phone. First, if the WLAN includes an Internet protocol sharing machine, such as a universal plug and play Internet protocol sharing machine, then the wireless web phone can receive its network information from the Internet protocol sharing machine. Otherwise, if the WLAN does not include any Internet protocol sharing machine, then the present invention sets a plurality of communication devices, having established Internet connections with the wireless web phone, as leading servers. That is, when the wireless web phone cannot receive the network information from the Internet protocol sharing machine, the present invention tries to receive the network information from the communication devices having communicated with the wireless web phone according to a call history of the wireless web phone. Since the communication devices store the network information of the wireless web phone after communicating with the wireless web phone through the Internet, the present invention can get the network information from the communication devices. In addition, if the wireless web phone still cannot receive the network information from the communication devices having communicated with the wireless web phone, the present invention further provides a server for storing the network information of the wireless web phone. As a result, the wireless web phone can receive its network information certainly.

In short, when receiving the network information of the wireless web phone, the present invention tries to receive the network information from the Internet protocol sharing machine in the WLAN. If the wireless web phone cannot get the network information from the Internet protocol sharing machine, or if the WLAN does not include the Internet protocol sharing machine, then the present invention receives the network information from the communication devices having established network connections with the wireless web phone. If the wireless web phone still cannot get the network information from the communication devices, then the wireless web phone receives the network information from the server storing the network information.

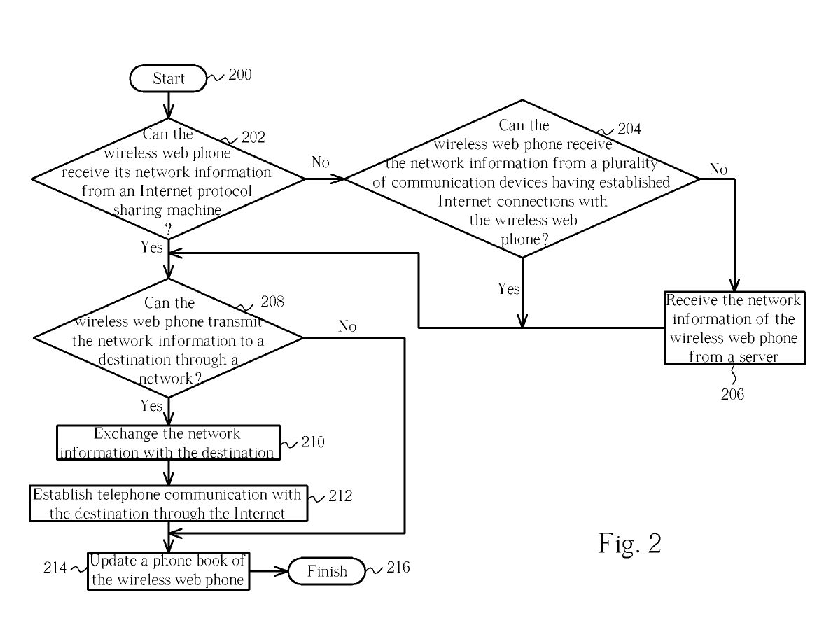

Please refer to FIG. 2, which illustrates a flowchart of a process 20 for establishing telephone communication with a wireless web phone in a wireless communication system in accordance with the second embodiment of the present invention. The process 20 includes following steps:

Step 200: start.

Step 202: determine whether the wireless web phone can receive its network information from an Internet protocol sharing machine or not. If so, then go to step 208, otherwise, go to step 204.

Step 204: receive the network information from a plurality of communication devices having established Internet connections with the wireless web phone. If the wireless web phone can receive the network information from the communication devices, then go to step 208, otherwise, go step 206.

Step 206: receive the network information of the wireless web phone from a server, and go to step 208.

Step 208: determine whether the wireless web phone can transmit the network information to a destination through a network or not. If so, then go to step 210, otherwise, go step 214.

Step 210: exchange the network information with the destination.

Step 212: establish telephone communication with the destination through the Internet.

Step 214: update a phone book of the wireless web phone.

Step 216: finish.

Therefore, after the wireless web phone calls the destination, the present invention determines whether the wireless web phone can receive its network information from the Internet protocol sharing machine or not. If not, then the wireless web phone tries to receive the network information from the communication devices having established Internet connections with the wireless web phone. If this still fails, then the wireless web phone can finally receive the network information from the server. As a result, the present invention can decrease chances of accessing the server, so as to reduce load of the server. Next, after receiving the network information, the wireless web phone transmits the network information to the destination through the network (such as a global system for mobile communication). According to a response from the destination, the wireless web phone determines whether the destination can establish the Internet connection or not. If the destination can establish the Internet connection, then the wireless web phone establishes telephone communication with the destination through the Internet, and updates the phone book.

Therefore, the present invention uses a wireless web phone to establish telephone communication through the Internet, so as to realize telephone communication with low charges and high quality, and provide services for the real-time exchange of images and files.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for establishing telephone communication with a wireless web phone capable of establishing a wireless local area network connection in a wireless communication system, comprising following steps:
(a) receiving network information of the wireless web phone when the wireless web phone calls a destination;
(b) transmitting the network information of the wireless web phone to the destination through a communication network; and
(c) establishing telephone communication with the destination through the Internet when a response from the destination represents that the destination is capable of establishing an Internet connection.

2. The method of claim 1, wherein the network information of the wireless web phone describes an Internet protocol address and an available port of the wireless web phone.

3. The method of claim 1, wherein in step (a), the network information is received through an Internet protocol sharing machine.

4. The method of claim 3, wherein the Internet protocol sharing machine is a universal plug and play Internet protocol sharing machine.

5. The method of claim 1, wherein in step (a), the network information is received through a server.

6. The method of claim 5, wherein the server is a device having established a network connection with the wireless web phone.

7. The method of claim 5, wherein the server is a device for storing the network information of the wireless web phone in the wireless communication system.

8. The method of claim 1, wherein in step (b), the network information of the wireless web phone is transmitted to the destination through a telephone network.

9. The method of claim 8, wherein the telephone network is a global system for mobile communication.

10. The method of claim 8, wherein the telephone network is a public switched telephone network.

11. The method of claim 1, wherein step (c) further comprising establishing telephone communication through a mobile phone network when the destination is not capable of establishing the Internet connection.

12. A method for receiving network information of a web phone comprising:
receiving the network information of the web phone from a plurality of communication devices having established network connections with the web phone.

13. The method of claim 12, wherein the network information of the web phone is received from the communication devices having established network connections with the web phone through a public switched telephone network.

14. The method of claim 12, wherein the network information of the web phone is received from the communication devices having established network connections with the web phone through a global system for mobile communication.

15. The method of claim 12, wherein the network information of the web phone describes an Internet protocol address and an available port of the web phone.
